(19) United States
(12) Patent Application Publication
(10) Pub. No.: US 2020/0034024 A1
(43) Pub. Date: Jan. 30, 2020

(54) TERMINAL, VIEW CHARACTER COPYING METHOD THEREOF, AND STORAGE APPARATUS

(71) Applicant: HUIZHOU TCL MOBILE COMMUNICATION CO.,LTD., Huizhou City (CN)

(72) Inventor: Jipeng SUN, Huizhou City (CN)

(73) Assignee: HUIZHOU TCL MOBILE COMMUNICATION CO.,LTD., Huizhou City (CN)

(21) Appl. No.: 16/478,126

(22) PCT Filed: Jul. 5, 2018
(86) PCT No.: PCT/CN2018/094648

§ 371 Date: Jul. 15, 2019

(30) Foreign Application Priority Data
Jul. 17, 2017 (CN) 201710582256.1

(51) Int. Cl. G06F 3/0484; G06F 17/24; G06F 9/451

(52) U.S. Cl. CPC G06F 3/04842; G06F 9/451; G06F 17/24

(57) ABSTRACT

The present disclosure provides a terminal, a view character copying method thereof, and a storage apparatus. The copying method may include: receiving a triggering operation of a user, and determining a view of which character copying needs to be executed according to the triggering operation; invoking a bottom layer interface to set an attribute of the view to be editable; receiving a clicking operation performed to the view and copying characters between a start position and an end position. Based on this method, the present disclosure may allow users to copy and paste characters in the view at will, improving user experience.

### CROSS REFERENCE TO RELATED APPLICATIONS

The present application is a 35 U.S.C. § 371 National Phase conversion of International (PCT) Patent Application No. PCT/CN2018/094648 filed on Jul. 5, 2018, which claims foreign priority of Chinese Patent Application No. 201710582256.1, filed on Jul. 17, 2017, in China National Intellectual Property Administration, the contents of all of which are hereby incorporated by reference.

### TECHNICAL FIELD

The present disclosure relates to the field of internet technology (IT), and in particularly to a terminal, a view character copying method of the terminal, and a storage apparatus.

### BACKGROUND

To improve visual sensory experience of users, most application programs in the market achieve animation effects via the Animation function. The animation effects may include movement, expanding, contraction, and gradient of controls and a combination of various animations. The nature of making animations to the controls is making animation effects to a view. When operations are executed to the view, users may usually copy the view. However, as a view, it may contain characters that cannot be copied and pasted. For example, texts in the view may not be copied, or all the texts in the view must be copied and pasted as a whole, followed by selecting unwanted text to delete, which impacts user experience.

### SUMMARY OF THE DISCLOSURE

Given the above, the present disclosure may provide a terminal, a view character copying method of the terminal, and a storage apparatus, so that the characters in the view may be copied and pasted at will to improve user experience.

The view character copying method provided by an embodiment of the present disclosure may include: receiving a triggering operation of a user, and determining a view of which character copying needs to be executed accordingly; invoking a bottom layer interface of the view, and setting an attribute of the view to be editable; receiving a clicking operation performed by the user, acquiring a start position and an end position of copying, and copying characters between the start and the end positions.

An embodiment of the present disclosure may provide a terminal, which can copy view characters. The terminal may include a processor and a transceiver connected to the processor. The transceiver may be arranged to receive triggering operations of a user. The processor may be arranged to determine the view of which character copying needs to be executed according to the triggering operations and invoke a bottom layer interface of the view to set an attribute of the view to be editable. The transceiver may be further arranged to receive clicking operations of the view. The processor may be further arranged to acquire a start position and an end position of a copying operation according to the clicking operation and copy the characters between the start and the end positions.

An embodiment of the present disclosure may provide a storage apparatus having program data stored, wherein the program data may be executed to achieve the above-mentioned method of copying the view characters.

The present disclosure may set an attribute of the view to be editable by invoking a bottom layer interface, so that a start position and an end position of characters in the view may be set at will. In such a way, users may select characters in the view at will, so that the characters may be copied and pasted freely, and user experience may be improved.

### BRIEF DESCRIPTION OF THE DRAWINGS

FIG. 1 is a flow chart illustrating a view character copying method provided by an embodiment of the present disclosure.

FIG. 2 is a flow chart illustrating a method of copying a plurality of sections of the view characters based on the method shown in FIG. 1.

FIG. 3 is a structural diagram of a terminal that can copy view characters provided by an embodiment of the present disclosure.

### DETAILED DESCRIPTION

Technical solutions of each exemplary embodiments of the present disclosure are to be described clearly and comprehensively, accompanying with appended figures. Without confliction, each of the following embodiments and features of the embodiments may be combined.

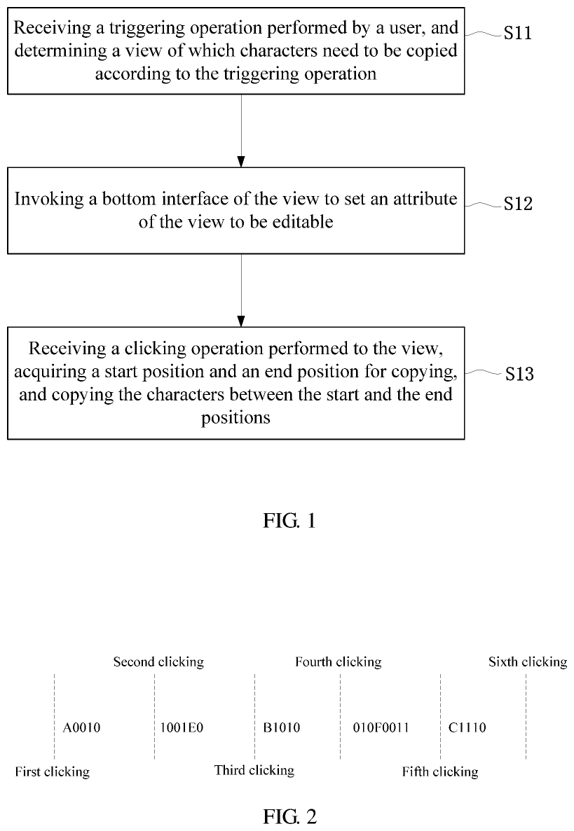

FIG. 1 is a flow chart illustrating a view character copying method provided by an embodiment. Referring to FIG. 1, the copying method provided herein may include operations of S11-S13.

S11: a triggering operation of a user may be received, and a view of which character copying needs to be executed may be determined accordingly.

The triggering operation of the user may be treated as an indication of entering a mode of copying. In an actual application scenario, the triggering operation may include but not be limited to long pressing, double clicking, and mono clicking the view. The long pressing may be interpreted as the user pressing a region of where the view is located by a finger or selecting the region by a physical button for a preset period of time. As an example of long pressing a touch screen, after an operation platform receiving the long pressing operation performed to the view by the user, the displayed view corresponding to the region long pressed by the user may be acquired by reverse mapping, so that the view of which character copying needs to be executed may be determined.

In order to distinguish the view of which character copying needs to be executed from other views, the present disclosure may set flag variables of the view determined by the triggering operation. The operation platform may only need to recognize flag variables to quickly determine the view of which character copying needs to be executed, so that subsequent operations may be executed easily.

S12: a bottom layer interface of the view may be invoked to set the attribute of the view to be editable.

An operation platform installed with Android as an example, in the present embodiment, a function of setTextIsSelectable of the bottom interface may be invoked. For example, the function of setTextIsSelectable may be set to be true, so that the attribute of the view may be editable. In the present embodiment, “editable” may correspond to transformation of the view into a data string or a piece of code, so that users may select or edit the data string or the piece of code.

In the present embodiment, after setting the attribute of the view to be editable, some other settings may be performed to the view, so that users may easily select characters that they want to copy. For example, a function of setTextAppearance may be invoked to set a style of the view. To be specific, through the operation platform, users may change character fonts and increase the size and spacing of the characters and the like. These operations of setting may be interpreted as “an operation of setting a copying mode” to the view, which may change the eventual displayed animation effect of the view.

S13: the clicking operation to the view may be received, the start and the end position of copying may be acquired, and characters between the start and the end positions may be copied.

After the view entering the copying mode, the first clicking operation of the user may be treated as an operation determining a start position, and the second clicking operation of the user may be treated as an operation determining an end position. After the second clicking operation, in the present embodiment, a dialog may pop up, for example, a floating dialog button with texts such as “to be copied or not” may pop up to ask the user whether the selection of the characters are finalized, and an immediate copying may be performed. When receiving a feedback from the user suggesting the selection of the characters is finalized and an immediate copying is to be performed, the characters between the start and the end positions may be copied. When the operation platform does not receive a feedback from the user suggesting the selection of the characters is finalized and an immediate copying is to be performed, a time countdown may be performed after the second clicking, and when counting down for a preset period of time, the instant recorded start and end positions may be deleted, and the present copying operation may be terminated.

Of course, in the present embodiment, the dialog may pop up after the first clicking to ask the user whether the instant clicking is valid. When the operation platform receives an affirmative message from the user, the instant clicking operation may be determined as valid, and a start position may be recorded. When the affirmative message is not received, and the preset period of time has been reached after the first clicking, the instant clicking operation may be treated as invalid, and an instant recorded start position may be deleted.

In the present embodiment, a plurality of sections of the view characters may be copied and pasted. Referring to FIG. 2, users may perform clicking operations to the view characters for more than two times as 1-n, wherein the n>2 and may be an even number. Odd numbers of times of clicking and even numbers of times of clicking may be flagged as start positions and end positions, respectively. Based on the sequence of the clicking operations, characters between an odd number of times of clicking and an even number adjacent to the odd number of times of clicking may be determined as the characters to be copied. To be specific, a character string A0010 between the first clicking operation and the second clicking operation, a character string B1010 between the third clicking operation and the fourth clicking operation, and a character string C1110 between the fifth clicking operation and the sixth clicking operation may be the characters to be copied. It should be understood that the characters may not be limited to digits and letters, linguistic characters and the like may also be included.

The operation of copying and pasting a plurality of sections may also be performed by the means of popping up a dialog. In addition, in the present embodiment, after each odd number and even number of times of clicking, character information copied each time by the user may be recorded through a string and placed in a sequential order. Line feeds and splicing may be performed to the character information.

In the present embodiment, after the copying is completed, the string may be saved in a clipboard, at the same time, all the operations during “an operation of setting a copying mode” may be restored, the flag variables of the view may also be restored, and the attribute of the view may be set to be non-editable.

It can be seen from the above that, in the present embodiment, the bottom layer interface may be invoked to set the attribute of the view to be editable, so that the start and the end positions of the characters in the view may be set at will. In such a way, the users may select characters in the view at will, so that copying and pasting may be performed freely, and user experience may be improved.

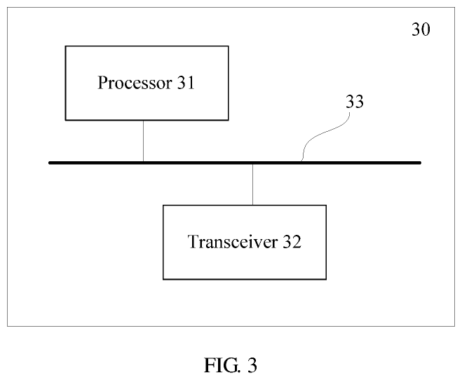

FIG. 3 is a structural diagram of a terminal that can copy view characters provided by an embodiment of the present disclosure. Referring to FIG. 3, a terminal 30 may include a processor 31, a transceiver 32 and a communication bus 33, wherein the processor 31 may connect with the transceiver 32 via the communication bus 33.

The transceiver 32 may be used to receive triggering operations of a user.

The processor 31 may be used to determine the view of which character copying needs to be executed according to the triggering operations and invoke the bottom interface of the view to set the attribute of the view to be editable.

The processor 31 may invoke the function of setTextIsSelectable to set the attribute of the view to be editable. After setting the attribute of the view to be editable, the processor 31 may set other attributes of the view to allow the users to select characters that they want to copy. For example, the function of setTextAppearance may be invoked to set a style of the view, including but not limiting to changing character fonts, character sizes, character spacing and the like.

The transceiver 32 may also be used to receive clicking operations performed to the view.

The processor 31 may be further used to acquire the start and the end positions for copying according to the clicking operations, and copy the characters between the start and the end positions.

In the present embodiment, the processor 31 may be used to copy and paste a plurality of characters in the view. To be specific, the processor 31 may flag an odd number of times of clicking and an even number of times of clicking as a start position and an end position, respectively. Based on a sequential order of the clicking operations, characters between each odd number of times of clicking and an even number adjacent to the odd number of times of clicking may be determined as the characters that need to be copied. Also, after each odd number and even number of times of clicking, the processor 31 may record each of the character information through a string, place the character information in a sequential order, and subsequently may perform line feeds or splicing to the character information.

The structural elements of the terminal 30 in the present embodiment may implement the method of copying the view characters as described in the above-mentioned embodiment correspondingly, and the same technical effects may be achieved. The terminal 30 may be a smart mobile phone, a personal digital assistant (PDA), a tablet computer and the like, and may also be a wearable apparatus or an apparatus that has a function of editing and operating the view and is inset in clothes, jewelries, and accessories

Further, the above-mentioned embodiments may be combined, and when the above-mentioned functions are realized in a form of software and can be sold or used as an independent product, a readable storage medium of an electronic device may be used for storage. Therefore, the present disclosure may provide a storage apparatus having program data stored, wherein the program data may be executed to perform the method as described in the above embodiments. The storage apparatus may be a universal serial bus flash disk, a CD-ROM disk, a server or the like. In other words, each of the embodiments of the present disclosure may be realized in a form of a software product, which may include a plurality of instructions to allow a smart terminal to execute a part or all of the operations in the methods described in the above-mentioned embodiments.

The above descriptions are only embodiments of the present disclosure, but should not limit the scope of the present disclosure. Any equivalent transformation of structures or processes based on the specification and appended figures of the present disclosure, such as combination of technical features from the embodiments or direct or indirect use of the features in other related fields, should also be within the scope of the present disclosure.

1. A method of copying view characters, wherein the method comprises:
receiving a triggering operation of a user and determining a view of which character copying needs to be executed according to the triggering operation;
invoking a bottom layer interface of the view and setting an attribute of the view to be editable; and
receiving a clicking operation performed to the view and acquiring a start position and an end position, and copying the characters between the start and the end positions.

2. The method according to claim 1, wherein the invoking a bottom layer interface of the view and setting the attribute of the view to be editable comprises:
invoking a function of setTextIsSelectable to set the attribute of the view to be editable.

3. The method according to claim 1, wherein the receiving the clicking operation performed to the view and acquiring the start position and the end position comprises:
flagging an odd number of times of clicking and an even number of times of clicking as the start and the end positions, respectively.

4. The method according to claim 3, wherein the copying the characters between the start and the end positions comprises:
after each even number of times of clicking, popping up a dialog to ask the user whether the selection of the characters is finalized, and an immediate copy is to be performed; and
when receiving a feedback from the user confirming the selection of the characters is finalized and an immediate copy is to be performed, the characters between the start and the end positions are copied.

5. The method according to claim 1, wherein the invoking the bottom layer interface of the view and setting the attribute of the view to be editable comprises:
invoking a function of setTextAppearance to set a style of the view.

6. The method according to claim 1, wherein the triggering operation of the user comprises finger pressing to select a region of where the view is located for a preset period of time, or pressing a physical button to select the region by double clicking or mono clicking.

7. The method according to claim 1, wherein the receiving the triggering operation of the user and determining the view of which character copying needs to be executed according to the triggering operation comprises:
setting a flag variable of the triggering operation determined view, and determining the view of which the character copying needs to be executed by recognizing the flag variable.

8. A terminal used to copy view characters, wherein the terminal comprises a processor and a transceiver connected to the processor, wherein
the transceiver is arranged to receive a triggering operation of a user;
the processor is arranged to determine the view of which character copying needs to be executed according to the triggering operation and invoke a bottom layer interface of the view to set an attribute of the view to be editable;
the transceiver is further arranged to receive a clicking operation that performed to the view; and
the processor is further arranged to acquire a start position and an end position according the clicking operation and copy the characters between the start and the end positions.

9. The terminal according to claim 8, wherein the processor invokes a function of setTextIsSelectable to set an attribute of the view to be editable.

10. The terminal according to claim 8, wherein the processor flags an odd number of times of clicking to be a start position and an even number of times of clicking to be an end position.

11. The terminal according to claim 8, wherein, after the bottom layer interface of the view to set the attribute to be editable is invoked, the processor is further arranged to invoke a function of setTextAppearance to set a style of the view.

12. The terminal according to claim 8, wherein the triggering operation of the user comprises finger pressing to select a region of which the view is located for a preset period of time, or pressing a physical button to select the region by double clicking or mono clicking.

13. The terminal according to claim 8, wherein the processor is further arranged to set a flag variable of the triggering operation determined view and determine the view of which the character copying needs to be executed by recognizing the flag variable.

14. A storage apparatus, wherein the storage apparatus has program data stored, and the program data is executed to implement a following method:
receiving a triggering operation performed by a user and determining a view of which character copying needs to be executed according to the triggering operation;
invoking a bottom layer interface of the view to set an attribute of the view to be editable; and
receiving a clicking operation performed to the view and acquiring a start position and an end position for copying, and copying the characters between the start and the end positions.

15. The storage apparatus according to claim 14, wherein, during the invoking the bottom interface of the view to set the attribute of the view to be editable, the program data is executed to invoke a function of setTextIsSelectable of the bottom interface to set the attribute of the view to be editable.

16. The storage apparatus according to claim 14, wherein, during the receiving the clicking operation performed to the view and the acquiring the start position and the end positions for copying, the program data is executed to flag an odd number of times of clicking to be a start position and an even number of times of clicking to be an end position.

17. The storage apparatus according to claim 16, wherein, during the copying the characters between the start and the end positions, the program data is executed to
pop up a dialog asking the user whether the selection of the characters is finalized and an immediate copy is to be performed after each even number of times of clicking; and
copy the characters between the start and the end positions when receiving a feedback from the user confirming the selection of the characters is finalized and an immediate copy is to be performed.

18. The storage apparatus according to claim 14, wherein, during the invoking the bottom layer interface of the view to set the attribute of the view to be editable, the program data is executed to invoke a function of setTextAppearance to set a style of the view.

19. The storage apparatus according to claim 14, wherein the triggering operation of the user comprises finger pressing to select a region of which the view is located for a preset period of time, or pressing a physical button to select the region by double clicking or mono clicking.

20. The storage apparatus according to claim 14, wherein, during the receiving the triggering operation performed by the user and determining the view of which character copying needs to be executed according to the triggering operation, the program data is executed to set a flag variable for the triggering operation determined view, and determine the view of which the character copying needs to be executed by recognizing the flag variable.
